(19) United States
(12) Patent Application Publication
(10) Pub. No.: US 2022/0136548 A1
(43) Pub. Date: May 5, 2022

(54) CLIP-SHELF FIXER

(71) Applicant: ZHEJIANG HONGGUOCUN LEISURE GOODS CO.,LTD., Yongkang City (CN)

(72) Inventor: Hongdou FANG, YONGKANG CITY (CN)

(21) Appl. No.: 17/085,814

(22) Filed: Oct. 30, 2020

(51) Int. Cl. F16B 12/42; F16B 12/32

(52) U.S. Cl. CPC F16B 12/42; A47B 55/02; F16B 12/32

(57) ABSTRACT

The present invention provides a clip-shelf fixer, comprising a pipe clip with two side clip-claws on both sides, which a bayonet is formed between the ends of the two side clip-claws and a pipe cavity is formed between the two side clip-claws, wherein the two side clip-claws on both sides are provided with a first portion of the two side clip-claws and a second portion of the two side clip-claws along the axial direction of the pipe cavity; there is an gap between the first portion and the second portion of the two side clip-claws, which is compatible with mesh wires of mesh plate, and at the end of the gap a first mesh wire connection part perpendicular to the axial direction of the pipe cavity is provided; the first mesh wire connection part is provided with a first mesh wire cavity, and the first mesh wire cavity is connected with the pipe cavity to form an integral pipe and mesh wire connection cavity. The present invention can connect the supporting pipe with the mesh plate steel wire intersecting with it, and each supporting pipe can be connected with the matched mesh plate on the support pipe, so as to avoid missing connection; and the overall structure of the clip-shelf fixer can be further strengthened by combining with the parallel steel wire connection structure.

### TECHNICAL FIELD

The present invention relates to a clip-shelf fixer, which is used to fix the support pipe rack and the mesh plate shelved on the support pipe rack.

### BACKGROUND

For simple wardrobe, shelf, hanging rack and so on, the support pipe rack will be set with mesh plate as the structure of shelving or hanging objects. The connection between the mesh plate and the support pipe rack will use the clip-shelf fixer. At present, the structure of connecting the support pipe and the steel wire parallel to the support pipe is adopted. When the parallel steel wire is just not on the support pipe, it is necessary to shift the mesh plate, especially the mesh plate needs to be connected with several parallel support pipes. The spacing between the two will not match, resulting in that at least part of the support pipes can not be connected with the steel wire connection on the mesh plate, which affects the strength of the connection, and makes the load of the clip-shelf fixer too large to affect the service life.

### SUMMARY

The technical problem to be solved by the present invention is to provide a clip-shelf fixer, which is convenient for each support pipe to be connected with the mesh plate on it, so as to avoid missing connection. Therefore, the present invention adopts the following technical scheme:

A clip-shelf fixer, comprising a pipe clip with two side clip-claws on both sides, which a bayonet is formed between the ends of the two side clip-claws and a pipe cavity is formed between the two side clip-claws, wherein the two side clip-claws are provided with a first portion of the two side clip-claws and a second portion of the two side clip-claws along the axial direction of the pipe cavity; there is an gap between the first portion and the second portion of the two side clip-claws, which is compatible with mesh wires of mesh plate, and at the end of the gap a first mesh wire connection part perpendicular to the axial direction of the pipe cavity is provided; the first mesh wire connection part is provided with a first mesh wire cavity, and the first mesh wire cavity is connected with the pipe cavity to form an integral pipe and mesh wire connection cavity.

On the basis of adopting the above-mentioned technical solutions, the present invention can also adopt the following further technical solutions or use them in combination:

The first mesh wire connection part is a groove structure.

The clip-shelf fixer is also provided with a second mesh wire connection part parallel to the axial direction of the pipe cavity, and the second mesh wire connection part is provided with a second mesh wire cavity; the first mesh wire cavity and the second mesh wire cavity are connected with the pipe cavity to form an integral pipe and mesh wire connection cavity.

The first and second mesh wire connection parts are both of a groove structure, and a cross groove structure is formed.

The groove wall of the groove structure protrudes out of the other side of the pipe clip, and the other side is the side opposite to the side with the bayonet.

The groove wall of the groove structure protrudes out of the other side of the pipe clip, and the other side is the side opposite to the side with the bayonet.

The two side clip-claws on both sides form a four claw structure by arranging the first portion and the second portion of the two side clip-claws on both sides along the axial direction of the pipe cavity, and having the gap that is compatible with the mesh wire between the first portion and the second portion of the two side clip-claws on both sides.

The two side clip-claws on both sides form a four claw structure that is reinforced by a protruded cross groove wall by arranging the first portion and the second portion of the two side clip-claws on both sides along the axial direction of the pipe cavity, and having the gap that is compatible with the mesh wire between the first portion and the second portion of the two side clip-claws on both sides.

Due to the adoption of the technical scheme of the present invention, the present invention can connect the support pipes with the mesh plate steel wire intersecting with the supporting pipe, and each supporting pipe can be connected with the mesh plate on the support pipe, so as to avoid missing connection, and the overall structure of the clip-shelf fixer can be further strengthened by combining with the parallel steel wire connection structure.

### BRIEF DESCRIPTION OF THE DRAWINGS

FIG. 1 is a schematic diagram of an embodiment of the present invention.

FIG. 2 is the main view of the embodiment of the present invention.

FIG. 3 is a side view of the embodiment of the present invention.

### DETAILED DESCRIPTION

Refer to the attached figures. The present invention provides a clip-shelf fixer, which comprises a pipe clip 100 with two side clip-claws on both sides; the two side clip-claws include a left side clip-claw 11 and a right side clip-claw 12, and a bayonet 101 is formed between the ends of the two side clip-claws, and a pipe cavity 102 for support pipe to pass through is formed between the two side clip-claws inside the bayonet. Under normal conditions, the outside diameter of bayonet 101 is slightly smaller than that of the connected support pipe. During connection, the two side clip-claws on both sides deform outwards by the reaction force of the support pipe. The bayonet 101 opens so that the pipe clip can be inserted into the support pipe. Then, the support pipe is clipped when the two side clip-claws on both sides are reset.

The two side clip-claws are arranged along the axial direction of the pipe cavity with the first portion of the two side clip-claws 103 and the second portion of the two side clip-claw 104. The first two portions of the two side clip-claws 103 and the second portion of the two side clip-claws 104 all have the left side claw 11 and the right side claw 12, and both have a bayonet and a pipe cavity, which can be sheathed and clipped into the support pipe.

Between the first portion and the second portion of the two side clip-claws are provided with an gap 200 adapted to the mesh wire of the mesh plate, and a first mesh wire connection part 201 perpendicular to the axial direction of the pipe cavity is arranged at the end of the gap 200; the first mesh wire connection part 201 is provided with a first mesh wire cavity 202, which the first mesh wire connection part 201 can adopt a groove structure, so that the first mesh wire cavity 202 is the space in the groove, and the width of the first mesh wire cavity 202 can be slightly wider than the connected mesh wires or be basically tightly matched. When the mesh plate is shelved on the support pipe, there must be steel wire crossing vertically or basically vertically on the support pipe. The gap 200 of the present invention is aligned with the mesh wire to be connected. When the pipe clip is clipped into the support pipe, the mesh wire also passes through the gap. When the support pipe is clipped, the mesh wire also falls into the first mesh cavity 202 of the first mesh wire connection part 201, so as to connect the support pipe and the mesh wire of the mesh plate together without shifting the mesh plate, and there is no missing connection due to the position misalignment.

The clip-shelf fixer is also provided with a second mesh wire connection part 301 parallel to the axial direction of the pipe cavity, and the second mesh wire connection part 301 is provided with a second mesh wire cavity 302; the second mesh wire connection part 301 can also be a groove structure, so that the second mesh wire cavity 302 is the space in the groove, and the width of the second mesh wire cavity 302 can be slightly wider than or basically tight matched with the connected mesh wire. In this way, when the mesh plate is on the support pipe, it can also be selectively connected with the parallel mesh wire on the support pipe. At this time, even for the connection of the parallel mesh wire, it is not necessary to move the mesh plate, and the most suitable position can be freely selected to connect the mesh wire and the support pipe.

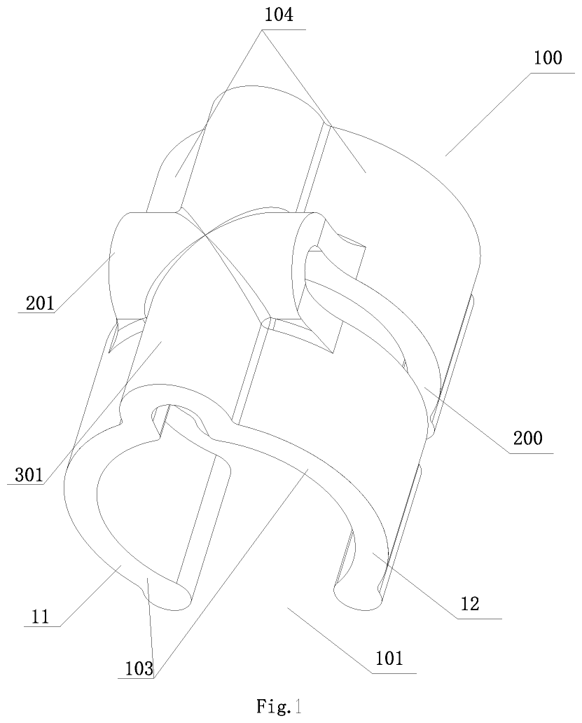

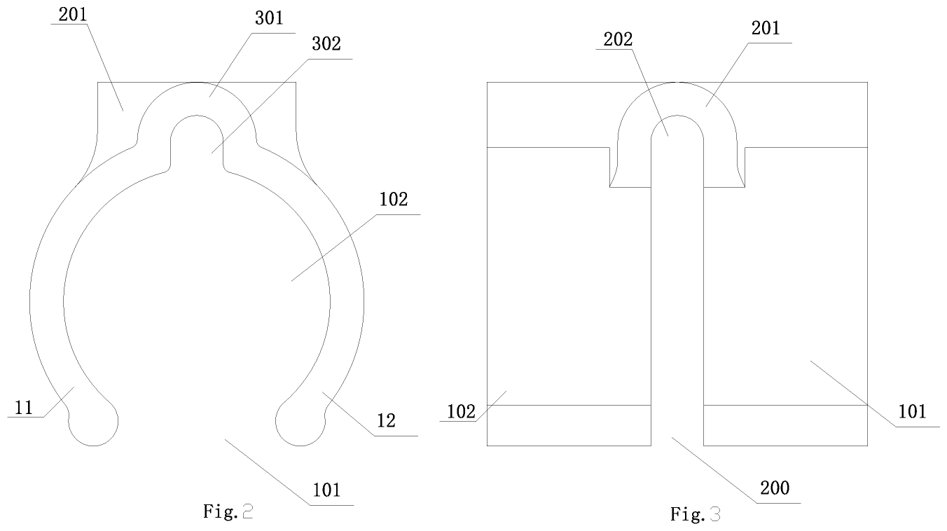

The first mesh wire cavity and the second mesh wire cavity are connected with the pipe cavity to form an integral pipe and mesh wire connection cavity. The second mesh wire connection part 301 and the first positioning part 201 also form a cross groove structure, and the groove wall of the groove structure protrudes out of the other side of the pipe clip, as shown in FIG. 1. In this way, the present invention not only has the advantages of accurate connection and convenient connection, but also can further play the role of strengthening the clip-shelf fixer structure.

As described above, the two side clip-claws form a four-claw structure by arranging the first portion of the two side clip-claws 103 and the second portion of the two side clip-claws 104 along the axial direction of the tube cavity, and the gap 200, which adapted to the mesh wire, between the first portion of the two side clip-claws 103 and the second portion of the two side clip-claws 104, which has better shape adaptability and stability, and the four-claw structure is a reinforced four-claw structure with cross groove wall reinforcement structure, with a more solid structure.

1. A clip-shelf fixer, comprising a pipe clip with two side clip-claws on both sides, which a bayonet is formed between the ends of the two side clip-claws and a pipe cavity is formed between the two side clip-claws, wherein the two side clip-claws on both sides are provided with a first portion of the two side clip-claws and a second portion of the two side clip-claws along the axial direction of the pipe cavity; there is an gap between the first portion and the second portion of the two side clip-claws, which is compatible with mesh wires of mesh plate, and at the end of the gap a first mesh wire connection part perpendicular to the axial direction of the pipe cavity is provided; the first mesh wire connection part is provided with a first mesh wire cavity, and the first mesh wire cavity is connected with the pipe cavity to form an integral pipe and mesh wire connection cavity.

2. The clip-shelf fixer according to claim 1, wherein the first mesh wire connection part is a groove structure.

3. The clip-shelf fixer according to claim 1, wherein the clip-shelf fixer is also provided with a second mesh wire connection part parallel to the axial direction of the pipe cavity, and the second mesh wire connection part is provided with a second mesh wire cavity; the first mesh wire cavity and the second mesh wire cavity are connected with the pipe cavity to form an integral pipe and mesh wire connection cavity.

4. The clip-shelf fixer according to claim 3, wherein the first and second mesh wire connection parts are both of a groove structure, and the groove structure of the first and second mesh wire connection parts traverse each other to form a cross groove structure.

5. The clip-shelf fixer according to claim 2, wherein a groove wall of the groove structure protrudes out of a first side of the pipe clip, and the first side is opposite to a second side of the pipe clip which includes the bayonet.

6. The clip-shelf fixer according to claim 4, wherein the groove wall of the groove structure protrudes out of the other side of the pipe clip, and the other side is the side opposite to the side with the bayonet.

7. The clip-shelf fixer according to claim 1, wherein the two side clip-claws on both sides form a four claw structure by arranging the first portion and the second portion of the two side clip-claws on both sides along the axial direction of the pipe cavity, and having the gap that is compatible with the mesh wire between the first portion and the second portion of the two side clip-claws on both sides.

8. The clip-shelf fixer according to claim 6, wherein the two side clip-claws on both sides form a four claw structure that is reinforced by a protruded cross groove wall by arranging the first portion and the second portion of the two side clip-claws on both sides along the axial direction of the pipe cavity, and having the gap that is compatible with the mesh wire between the first portion and the second portion of the two side clip-claws on both sides.
